(19) United States
(12) Patent Application Publication
(10) Pub. No.: US 2020/0182638 A1
(43) Pub. Date: Jun. 11, 2020

(54) OPERATION SUPPORT DEVICE, OPERATION SUPPORT SYSTEM, AND OPERATION SUPPORT PROGRAM

(71) Applicant: TOYOTA JIDOSHA KABUSHIKI KAISHA, Toyota-shi (JP)

(72) Inventors: Koichi SUZUKI, Miyoshi-shi (JP); Ryo KANDA, Nisshin-shi (JP); Daiki KUBO, Toyota-shi (JP); Koichiro MITSUMAKI, Nagoya-shi (JP); Miku ANDO, Miyoshi-shi (JP); Shunji TATEISHI, Kasugai-shi (JP); Yoshitaka MASUDA, Okazaki-shi (JP)

(73) Assignee: TOYOTA JIDOSHA KABUSHIKI KAISHA, Toyota-shi (JP)

(21) Appl. No.: 16/595,910

(22) Filed: Oct. 8, 2019

(30) Foreign Application Priority Data
Dec. 10, 2018 (JP) 2018-231196

(51) Int. Cl. G01C 21/34; G06K 9/00; G06Q 10/04; G06Q 50/30

(52) U.S. Cl. CPC G01C 21/3438; G06K 9/00791; G06Q 50/30; G01C 21/3453; G06Q 10/047; G06K 9/00362

(57) ABSTRACT

An operation support device includes a control unit configured to output operation support information regarding an operation vehicle that operates along an operation route passing through prescribed boarding-dropping points to board or drop a passenger at the prescribed boarding-dropping points. The control unit is configured to detect person information from an in-vehicle camera image by a photographing vehicle. The control unit is configured to detect a potential passenger at the prescribed boarding-dropping points based on the person information. The control unit is configured to output the operation support information based on a detection result of the potential passenger.

### INCORPORATION BY REFERENCE

The disclosure of Japanese Patent Application No. 2018-231196 filed on Dec. 10, 2018 including the specification, drawings and abstract is incorporated herein by reference in its entirety.

### BACKGROUND

### 1. Technical Field

The present disclosure relates to an operation support device, an operation support system, and an operation support program.

### 2. Description of Related Art

Systems for efficiently transporting passengers have conventionally been known. For example, Japanese Patent Application Publication No. 2003-168193 discloses a system configured to provide an extra service, based on the number of passengers riding in a vehicle, the number of passengers waiting at each stop, and the location of the vehicle.

### SUMMARY

Considering from the viewpoint of an organization that operates operation vehicles, such as buses, operated for transportation of the passengers, efficient operation of the operation vehicles is expected. Considering from the viewpoint of passengers of the operation vehicles, boarding without missing the operation vehicles is expected. In short, enhanced convenience for both the organization that operates the operation vehicles and the passengers boarding the operation vehicles is expected.

An object of the present disclosure made in view of these circumstances is to enhance the convenience of the operation vehicles.

An operation support device according to one embodiment of the present disclosure includes a control unit configured to output operation support information regarding an operation vehicle that operates along an operation route passing through prescribed boarding-dropping points to board or drop a passenger at the prescribed boarding-dropping points. The control unit is configured to detect person information from an in-vehicle camera image by a photographing vehicle that is different from the operation vehicle, detect a potential passenger at the prescribed boarding-dropping points based on the person information, and output the operation support information based on a detection result of the potential passenger.

An operation support system according to one embodiment of the present disclosure includes an operation vehicle, a photographing vehicle, and an operation support device. The operation vehicle is configured to operate along an operation route passing through prescribed boarding-dropping points to board or drop a passenger at prescribed boarding-dropping points. The photographing vehicle is different from the operation vehicle. The operation support device includes a control unit configured to output operation support information regarding the operation vehicle. The control unit of the operation support device is configured to detect person information from an in-vehicle camera image by the photographing vehicle, detect a potential passenger at the prescribed boarding-dropping points based on the person information, and output the operation support information based on a detection result of the potential passenger.

An operation support program according to one embodiment of the present disclosure causes a processor to execute the steps of: acquiring an in-vehicle camera image by a photographing vehicle that is different from an operation vehicle that operates along an operation route passing through prescribed boarding-dropping points to board or drop a passenger at the prescribed boarding-dropping points, detecting person information from the in-vehicle camera image, detecting a potential passenger at the prescribed boarding-dropping points based on the person information; and outputting operation support information regarding the operation vehicle based on a detection result of the potential passenger.

The operation support device, the operation support system, and the operation support program according to one embodiment of the present disclosure can enhance the convenience of the operation vehicle.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic view showing a configuration example of an operation support system according to one embodiment;

FIG. 2 is a block diagram showing a configuration example of the operation support system according to the embodiment;

FIG. 3 is a block diagram showing a configuration example of an in-vehicle camera and an image analysis unit;

FIG. 4 is a flowchart showing an example of the procedures of an operation support method;

FIG. 5 is a flowchart showing an example of the procedures for generating a database where passengers and boarding points are associated;

FIG. 6 is a flowchart showing an example of the procedures for determining the necessity to stop at a yet-to-be-reached point with reference to the database;

FIG. 7 is a flowchart showing an example of the procedures for controlling the operation of a bus based on the determination regarding the necessity to stop at the yet-to-be-reached point;

FIG. 8 is a flowchart showing an example of the procedures for determining whether to bypass a point where it is not necessary to stop; and

FIG. 9 is a block diagram showing a configuration example of an operation support system including a bus that includes an operation support device.

### DETAILED DESCRIPTION OF EMBODIMENTS

### Configuration Example of Operation Support System in One Embodiment

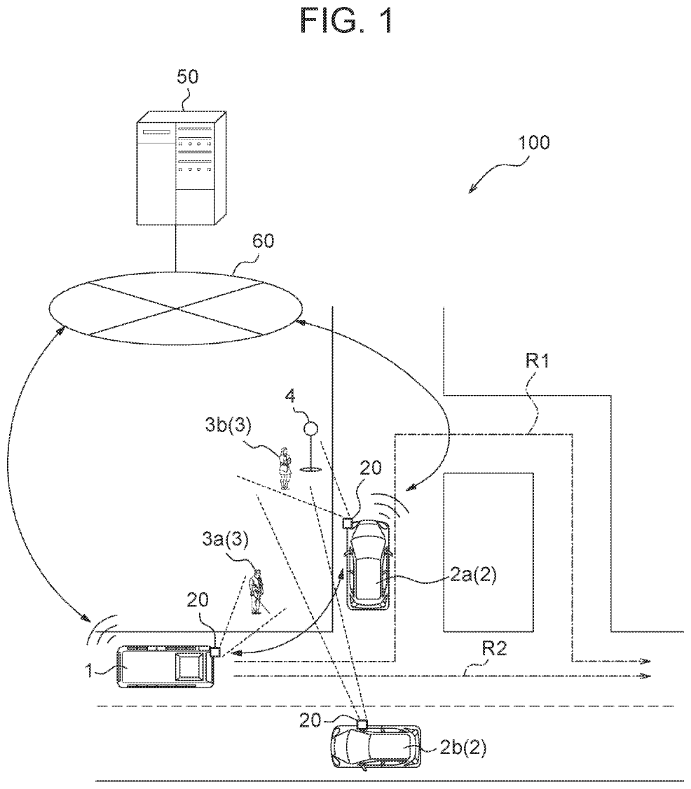

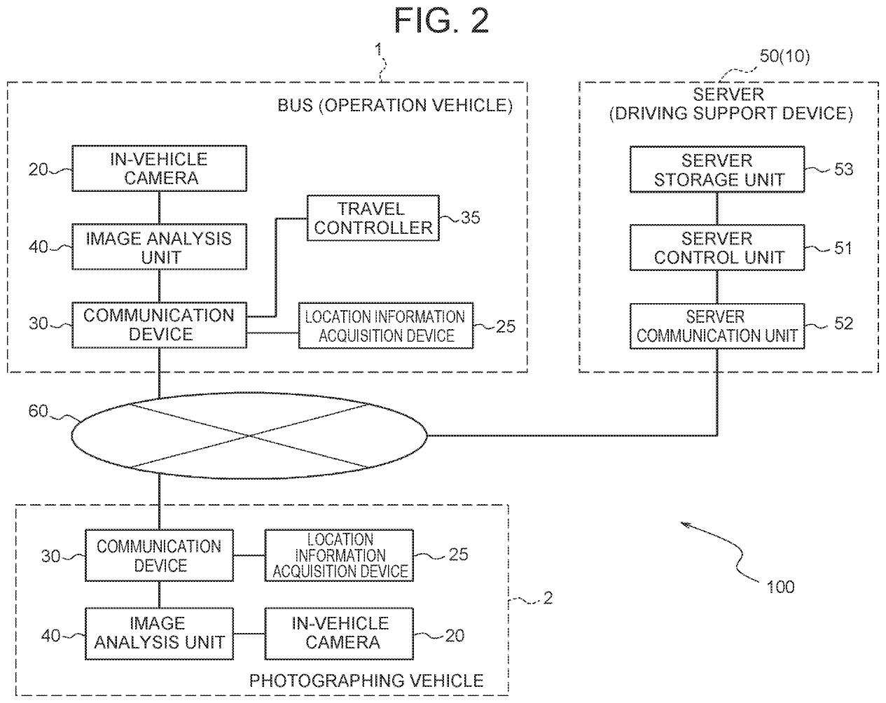

As shown in FIGS. 1 and 2, an operation support system 100 according to one embodiment includes a bus 1. The bus 1 is a vehicle that operates to transport passengers. The bus 1 is also referred to as an operation vehicle. Without being limited to the bus 1, the operation vehicle may be replaced with passenger transportation means of other types, such as a shared-taxi. The operation support system 100 may include one or more buses 1.

The operation support system 100 further includes a photographing vehicle 2. The photographing vehicle 2 is a vehicle that is different from the operation vehicle such as the bus 1. Although the photographing vehicle 2 is, for example, an automobile, the photographing vehicle 2 may be any vehicle without being limited to the automobile. The operation support system 100 may include two or more photographing vehicles 2.

The bus 1 and the photographing vehicle 2 included in the operation support system 100 can communicate with each other. When the operation support system 100 includes two or more buses 1, the buses 1 may be communicable with each other. When the operation support system 100 includes two or more photographing vehicles 2, the photographing vehicles 2 may be communicable with each other. Vehicles including the bus 1 and the photographing vehicle 2 may each communicate with other vehicles through a network 60, or may directly communicate with other vehicles without through the network 60.

The operation support system 100 may further include a server 50. The bus 1 and the photographing vehicle 2 are communicable with the server 50. The bus 1 and the photographing vehicle 2 may communicate with the server 50 through the network 60.

The server 50 includes a server control unit 51, a server communication unit 52, and a server storage unit 53. The server control unit 51 may include one or more processors. In the present embodiment, “processor” is a general-purpose processor, a processor dedicated for specific processing, or the like. However, the “processor” is not limited to these. The server communication unit 52 may include a communication module to communicate with a communication device 30 of the bus 1 and the photographing vehicle 2. The server storage unit 53 may include one or more memories. Although examples of the “memory” include a semiconductor memory, a magnetic memory, or an optical memory in the present embodiment, the memory is not limited to these. The memory or memories included in the server storage unit 53 may each function as a main storage, an auxiliary storage, or a cache memory, for example. The server storage unit 53 may include an electromagnetic storage medium, such as a magnetic disk. The server storage unit 53 stores therein any information that is used for operation of the server 50. For example, the server storage unit 53 may store therein information such as system programs or application programs.

The operation support system 100 includes an operation support device 10. The operation support device 10 outputs information that supports operation of the operation vehicle such as the bus 1. The information that supports the operation of the operation vehicle is also called operation support information. The operation support information may include, for example, information regarding an operation route of the operation vehicle, and may also include information regarding an operation schedule of the operation vehicle. When the operation vehicle is the bus 1, the bus 1 may allow a passenger to board or drop off at a prescribed bus stop 4 that is located on the operation route, or may allow a passenger to board or drop off at any point on the operation route. The point where the bus 1 allows a passenger to board or drop off is also called a boarding-dropping point. In the present embodiment, the operation route of the bus 1 is assumed to be a route expressed by a chain line as R1 in FIG. 1. The boarding-dropping point is assumed to be the bus stop 4 located on the road side of a road along the operation route.

The operation support device 10 may be implemented by one or more processors. The operation support device 10 may be implemented as one of the functions of the server 50. In short, the server control unit 51 may function as a control unit of the operation support device 10. The operation support device 10 may be mounted on the bus 1. In the embodiment illustrated in FIG. 2, the operation support device 10 is implemented as one of the functions of the server 50.

The bus 1 has an in-vehicle camera 20, a location information acquisition device 25, a communication device 30, a travel controller 35, and an image analysis unit 40 mounted thereon. The in-vehicle camera 20, the location information acquisition device 25, the communication device 30, the travel controller 35, and the image analysis unit 40 are communicably connected with each other through an in-vehicle network such as a controller area network (CAN) or an exclusive line, for example.

The photographing vehicle 2 has an in-vehicle camera 20, a location information acquisition device 25, a communication device 30, and an image analysis unit 40 mounted thereon. The in-vehicle camera 20, the location information acquisition device 25, the communication device 30, and the image analysis unit 40 are communicably connected with each other through an in-vehicle network such as CAN or an exclusive line, for example.

The travel controller 35 mounted on the bus 1 controls the travel of the bus 1. The travel controller 35 may include one or more processors. The travel controller 35 may be implemented as one of the functions of an electronic control unit (ECU). In the present embodiment, the bus 1 travels under automated driving control executed by the travel controller 35. The automated driving includes, for example, any one of levels 1 to 5 defined by Society of Automotive Engineers (SAE). However, without being limited to these, the automated driving may freely be defined. In another embodiment, the bus 1 may travel based on driving by a driver. When the bus 1 travels based on driving by a driver, the travel controller 35 may output information that instructs a travel route to the driver. When the bus 1 travels based on driving by a driver, the bus 1 may not include the travel controller 35. Instead, the information may be output to the driver through the communication device 30.

The communication device 30 mounted on the bus 1 and the photographing vehicle 2 communicates with the communication devices 30 mounted on other vehicles. The communication device 30 may communicate with the communication devices 30 mounted on other vehicles through the network 60. The communication device 30 may directly communicate with the communication devices 30 mounted on other vehicles without through the network 60. In the present embodiment, it is assumed that the buses 1 and the photographing vehicles 2 communicate with each other through the network 60. The communication device 30 may communicate with the server 50 through the network 60. The communication device 30 may be an in-vehicle communication module, such as a data communication module (DCM), for example. The communication device 30 may include a communication module connected to the network 60. Although the communication module may include a communication module in conformity with, for example, 4th generation (4G) and 5th generation (5G) mobile object communication standards, the communication module is not limited to these.

The in-vehicle camera 20 mounted on the bus 1 photographs objects located in the periphery or in a vehicle cabin of the bus 1. The in-vehicle camera 20 mounted on the photographing vehicle 2 photographs objects located in the periphery or in a vehicle cabin of the photographing vehicle 2. Images photographed by the in-vehicle cameras 20 are also called in-vehicle camera images. The in-vehicle camera images are associated with photographing location information or photographing time information. The in-vehicle camera images may include static images, and may also include moving images.

The in-vehicle cameras 20 photograph, as a detection target of the operation support system 100, a person or persons 3 present in the periphery of the bus 1 or the photographing vehicle 2. The bus 1 or the photographing vehicle 2 may output an in-vehicle camera image containing a person or persons 3 to the operation support device 10.

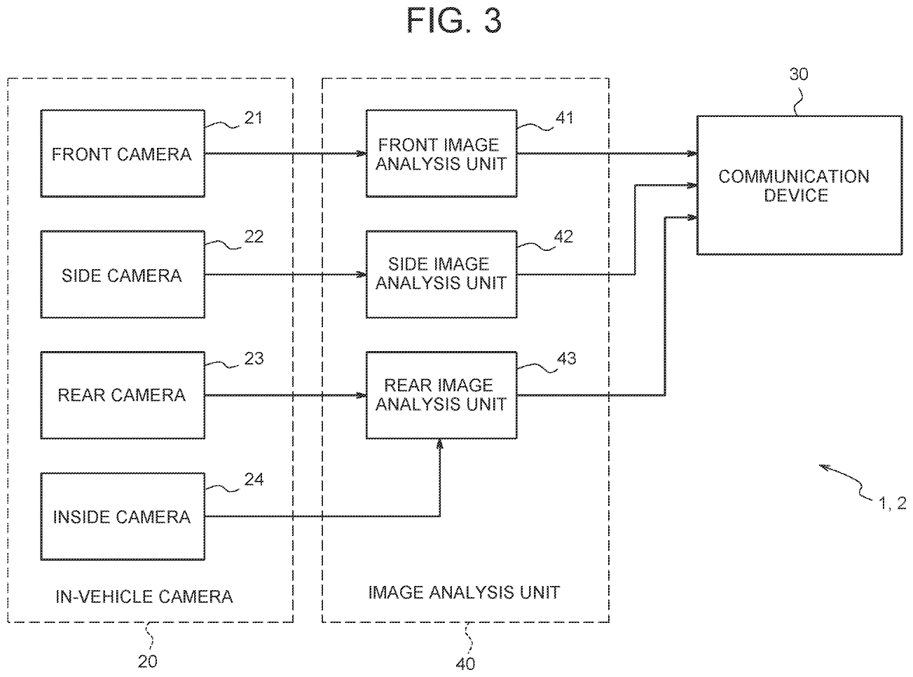

As illustrated in FIG. 3, the in-vehicle camera 20 may include at least one of a front camera 21, a side camera 22, a rear camera 23, and an inside camera 24. The front camera 21 photographs objects that are located in front of the bus 1 or the photographing vehicle 2. An image photographed by the front camera 21 is also called a front image. The side camera 22 photographs objects that are located on the side of the bus 1 or the photographing vehicle 2. An image photographed by the side camera 22 is also called a side image. The rear camera 23 photographs objects that are located in the rear of the bus 1 or the photographing vehicle 2. An image photographed by the rear camera 23 is also called a rear image. The inside camera 24 photographs objects that are located inside the cabin of the bus 1 or the photographing vehicle 2, and objects that are located in the rear of the bus 1 or the photographing vehicle 2. An image photographed by the inside camera 24 is also called an inside image.

The image analysis unit 40 mounted on each of the bus 1 and the photographing vehicle 2 analyzes in-vehicle camera images, and outputs an analysis result to the communication device 30. The image analysis unit 40 may be implemented by one or more processors. The image analysis unit 40 may be included in the in-vehicle camera 20. The image analysis unit 40 may include a front image analysis unit 41 that acquires a front image from the front camera 21 and analyzes the acquired front image. The image analysis unit 40 may include a side image analysis unit 42 that acquires a side image from the side camera 22 and analyzes the acquired side image. The image analysis unit 40 may include a rear image analysis unit 43 that acquires a rear image from the rear camera 23 and an inside image from the inside camera 24 and analyzes the rear image and an image of the objects in the rear of the bus 1 or the photographing vehicle 2 contained in the inside image.

The image analysis unit 40 may detect an image of a person 3 from the in-vehicle camera image, and output the detected image to the operation support device 10. The image of the person 3 is also called a person image.

The bus 1 or the photographing vehicle 2 may not include the image analysis unit 40. When the bus 1 or the photographing vehicle 2 does not include the image analysis unit 40, the in-vehicle camera 20 outputs in-vehicle camera images to the server 50 that implements the function of the operation support device 10, through the communication device 30. The operation support device 10 detects a person image from the in-vehicle camera images.

Information including at least one of an in-vehicle camera image and a person image is also called camera output information. Irrespective of whether the bus 1 or the photographing vehicle 2 includes the image analysis unit 40, it can be said that the operation support device 10 acquires the camera output information from at least one of the bus 1 and the photographing vehicle 2. The operation support device 10 detects information regarding a person 3 based on the person image. The information regarding the person 3 is also called person information. When the camera output information includes a person image, the operation support device 10 extracts the person image from the camera output information, and detects person information from the extracted person image. When the camera output information includes an in-vehicle camera image, the operation support device 10 detects a person image from the in-vehicle camera image, and detects person information from the detected person image.

The bus 1 and the photographing vehicle 2 have the location information acquisition device 25 mounted thereon that is communicably connected, through an in-vehicle network such as CAN or an exclusive line, with other component members mounted on the bus 1 and the photographing vehicle 2. The location information acquisition device 25 acquires location information regarding its own vehicle. The location information acquisition device 25 may include a receiver corresponding to a global positioning system. For example, the receiver corresponding to the global positioning system may include a global positioning system (GPS) receiver. In the present embodiment, the bus 1 and the photographing vehicle 2 can acquire location information regarding the bus 1 and the photographing vehicle 2 with use of the location information acquisition device 25. The bus 1 and the photographing vehicle 2 may associate corresponding in-vehicle camera images with the location information regarding the bus 1 and the photographing vehicle 2 acquired with the location information acquisition device 25, as the information regarding the location where the in-vehicle camera images are photographed.

The operation support system 100 illustrated in FIG. 1 detects person information regarding a person 3a who walks toward the bus stop 4 in order to board the bus 1, and a person 3b who waits for the bus 1 at the bus stop 4, based on the camera output information.

The person information may include location information regarding the person 3 based on the information regarding the location where the person image is photographed. The person information may include information regarding the time when the person image is photographed.

The person information may include information indicating the action of the person 3. When the person image includes a moving image, the operation support device 10 may detect information indicating the action of the person 3 based on the moving image. The operation support device 10 may detect the person 3 from each of the person images photographed at different time, and detect information indicating the action of the person 3. The information indicating the action of the person 3 may include information such as information indicating whether the person 3 stays at a current location or moves. In the example of FIG. 1, the operation support device 10 may detect the person 3a walking in the direction of the bus stop 4, as the person information regarding the person 3a. The operation support device 10 may detect the person 3b staying in the bus stop 4, as the person information regarding the person 3b.

The person information may include information indicating the state of the person 3. The information regarding the state of the person 3 may include information including, for example, information indicating that the person 3 uses a cane such as a walking assist cane, a crutch, or a white walking stick, carries a large package such as a suitcase, or sits on a wheelchair. In the example of FIG. 1, the operation support device 10 may detect the person 3a using a cane, as the person information.

The person information may also include biometric information peculiar to the person 3, such as the face or the iris of the eye of the person 3. Without being limited to these examples, the person information may include various pieces of information.

The operation support device 10 determines whether the person 3 boards the bus 1 at the bus stop 4 based on the detected person information regarding the person 3. The person 3 who boards the bus 1 at the bus stop 4 is also called a potential passenger. In short, the operation support device 10 detects a potential passenger or passengers of the bus stop 4 based on the person information. When detecting at least one potential passenger at the bus stop 4, the operation support device 10 determines that there is a potential passenger in the bus stop 4.

The operation support device 10 acquires the location where the bus 1 travels, and determines whether any potential passenger is present in a prescribed boarding-dropping point on an operation route. When any potential passenger is present in the prescribed boarding-dropping point, the operation support device 10 outputs operation support information including control information for controlling the bus 1 to travel toward the prescribed boarding-dropping point and stop at the prescribed boarding-dropping point. For example, when any potential passenger is present at the bus stop 4 in FIG. 1, the operation support device 10 may maintain a route passing through the bus stop 4 as an operation route of the bus 1 expressed as R1, and allow the bus 1 to travel toward the bus stop 4. When no potential passenger is present in the prescribed boarding-dropping point, the operation support device 10 may newly set a route without passing through the prescribed boarding-dropping point as an operation route of the bus 1, and may output operation support information including the information regarding the newly set route. For example, when no potential passenger is present in the bus stop 4 in FIG. 1, the operation support device 10 may change the operation route of the bus 1 to a route without passing through the bus stop 4 expressed as R2, and allow the bus 1 to travel straight. When the operation support device 10 sets a route without passing through the boarding-dropping point where no potential passenger is present, operational efficiency of the operation vehicle can be enhanced.

When a potential passenger or passengers are present in a prescribed boarding-dropping point, the bus 1 stops at the prescribed boarding-dropping point based on the operation support information. The operation support device 10 may output the operation support information including the control information for controlling the bus 1 to adjust arrival time at the prescribed boarding-dropping point, based on the speed of the potential passenger moving toward the prescribed boarding-dropping point. When detecting, based on the person information, that the potential passenger needs time to reach the prescribed boarding-dropping point, the operation support device 10 may output the operation support information including the control information for controlling the bus 1 to go slow.

The operation support device 10 confirms whether the potential passenger or passengers board the bus 1, after the bus 1 arrives at the prescribed boarding-dropping point. The operation support device 10 may output the operation support information including the control information for controlling the bus 1 to wait at the prescribed boarding-dropping point until all the persons 3 who are determined to be potential passengers board the bus 1. When detecting, as the person information regarding the potential passenger, the information indicating that the speed of the potential passenger moving toward the boarding-dropping location is slow, the operation support device 10 may estimate waiting time at the prescribed boarding-dropping point based on the information. The information indicating that the movement speed is slow may include various pieces of information, such as information indicating that the potential passenger uses a cane, the information indicating that the potential passenger carries a large package, or the information indicating that the potential passenger sits on a wheelchair, for example. When the operation support device 10 confirms boarding of all the potential passengers, the possibility of the users missing the operation vehicle is reduced. As a result, the convenience for the users of the operation vehicle is enhanced.

When the person 3 detected as a potential passenger walks past the bus stop 4, or starts to move in the direction away from the bus stop 4, the operation support device 10 may determine that the person 3 detected as a potential passenger is no longer a potential passenger of the bus stop 4. When the person 3 detected as a potential passenger stays in the bus stop 4 or in the periphery thereof, but does not move toward the bus 1 for a prescribed time or more after the bus 1 arrives at the bus stop 4, the operation support device 10 may determine that the person 3 is no longer a potential passenger of the bus stop 4. With such configuration, the operational efficiency of the bus 1 may be enhanced.

The operation support device 10 may detect a potential passenger based on the in-vehicle camera images photographed when the photographing vehicle 2 travels on an operation route of the bus 1. For example, in FIG. 1, a photographing vehicle 2a travels on the operation route (R1) of the bus 1. The operation support device 10 may detect a potential passenger at the bus stop 4 based on the in-vehicle camera images of the photographing vehicle 2a. The operation support device 10 may also detect a potential passenger based on the in-vehicle camera images photographed when the photographing vehicle 2 travels outside the operation route of the bus 1. For example, in FIG. 1, a photographing vehicle 2b travels outside the operation route (R1) of the bus 1. The operation support device 10 may detect a potential passenger of the bus stop 4 based on the in-vehicle camera images of the photographing vehicle 2b.

The operation support device 10 may detect a potential passenger of the bus stop 4 based on the in-vehicle camera images of the bus stop 4 and the periphery thereof. The operation support device 10 may detect a potential passenger at the bus stop 4 based on the in-vehicle camera images of a point that is distanced from the bus stop 4. The operation support device 10 can detect a potential passenger who has not yet arrived at the bus stop 4, based on the in-vehicle camera images.

As a comparative example, the configuration is assumed in which a fixed point camera or a human sensor is installed in the bus stop 4. In the configuration of the comparative example, a potential passenger who reaches the bus stop 4 is detectable, although a potential passenger who has not yet reached the bus stop 4 is undetectable. Contrary to this, the operation support device 10 according to the embodiment can detect the potential passenger who has not yet reached the bus stop 4 based on the in-vehicle camera images. According to the present embodiment, a detection range of the potential passenger becomes wider than that in the configuration according to the comparative example.

As described in the foregoing, the operation support device 10 according to the one embodiment can detect a potential passenger or passengers of the operation vehicle at a prescribed boarding-dropping point, and generate operation support information based on the presence of the potential passenger. Such configuration makes it possible to achieve efficient operation of the operation vehicle and to allow the user to board without missing the operation vehicle. As a result, the convenience of the operation vehicle is enhanced.

### Example of Operation Support Method

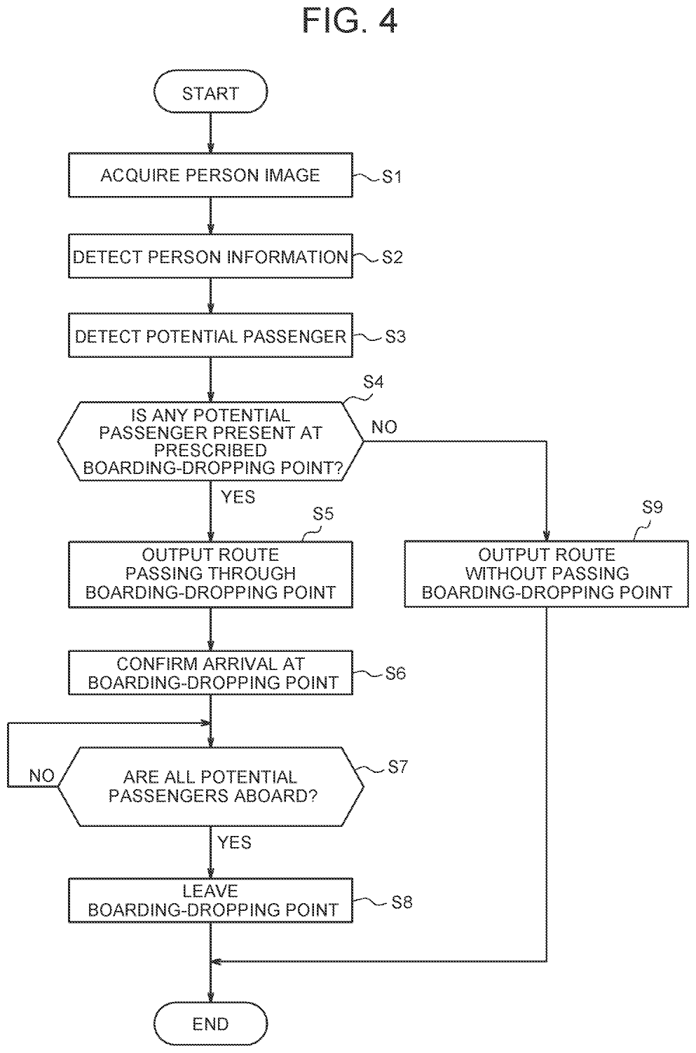

The operation support device 10 may execute an operation support method including the procedure of a flowchart illustrated in FIG. 4. The operation support method may be implemented as an operation support program executed by a processor.

The operation support device 10 acquires a person image (step S1). The operation support device 10 acquires camera output information from the in-vehicle camera 20 or the image analysis unit 40. When the camera output information includes a person image, the operation support device 10 extracts the person image from the camera output information. When the camera output information includes an in-vehicle camera image, the operation support device 10 detects a person image from the in-vehicle camera image.

The operation support device 10 detects person information from the person image (step S2).

The operation support device 10 detects a potential passenger of the bus 1 at a boarding-dropping point based on the person information (step S3).

The operation support device 10 determines whether any potential passenger of the bus 1 is present at the prescribed boarding-dropping point (step S4).

When no potential passenger of the bus 1 is present at the prescribed boarding-dropping point (step S4: NO), the operation support device 10 proceeds to the procedure of step S9. When any potential passenger of the bus 1 is present at the prescribed boarding-dropping point (step S4: YES), the operation support device 10 outputs, as the operation support information, the information specifying a route passing through the prescribed boarding-dropping point as an operation route (step S5).

The operation support device 10 confirms arrival of the bus 1 at the prescribed boarding-dropping point (step S6).

The operation support device 10 determines whether all the potential passengers at the prescribed boarding-dropping point board the bus 1 (step S7).

When not all the potential passengers board the bus 1 (step S7: NO), the operation support device 10 continues determination of step S7. In short, the operation support device 10 makes the bus 1 wait at the prescribed boarding-dropping point until all the potential passengers board the bus 1 at the prescribed boarding-dropping point.

When all the potential passengers board the bus 1 (step S7: YES), the operation support device 10 outputs the operation support information that allows the bus 1 to leave the prescribed boarding-dropping point (step S8). After executing the procedure of step S8, the operation support device 10 ends the execution of the procedure shown in the flowchart of FIG. 4.

When no potential passenger of the bus 1 is present at the prescribed boarding-dropping point (step S4: NO) in the determination procedure in step S4, the operation support device 10 outputs, as the operation support information, the information specifying a route without passing through the prescribed boarding-dropping point as an operation route (step S9). After executing the procedure of step S9, the operation support device 10 ends the execution of the procedure shown in the flowchart of FIG. 4.

As described in the foregoing, in the operation support method according to the one embodiment, a potential passenger of the operation vehicle at a prescribed boarding-dropping point may be detected. The operation support information regarding the operation vehicle may be determined based on the presence of the potential passenger of the operation vehicle. Such configuration makes it possible to achieve efficient operation of the operation vehicle and to allow the user to board without missing the operation vehicle. As a result, the convenience of the operation vehicle is enhanced. Determination Based on Authentication Data

The operation support system 100 according to one embodiment may detect a potential passenger of the bus 1 at a prescribed boarding-dropping point by authenticating the person 3 detected from a person image based on authentication data. When authenticating the person 3 based on authentication data, the operation support system 100 may acquire in advance the authentication data with which the person 3 can be authenticated as a potential passenger of the bus 1. The authentication data may include data collated with the person information regarding the person 3. In the present embodiment, the authentication data includes the data collated with information obtained by extracting features of the face of the person 3. The information obtained by extracting features of the face of the person 3 is also called face information. In this case, the operation support system 100 can authenticate the person 3 as a potential passenger by collating the face information, regarding the person 3 extracted from the person image, with the authentication data.

In the case of using the authentication data, the operation support system 100 associates location information regarding a boarding-dropping point and the authentication data based on the face information regarding the person 3 who has boarded the bus 1 at the boarding-dropping point. The operation support system 100 may generate a database where the location information regarding the boarding-dropping point is associated with the authentication data. In short, the operation support system 100 may generate the database of a history of boarding the bus 1 at each boarding-dropping point. Based on the information where the location information regarding the boarding-dropping points and the authentication data are associated with each other, the operation support system 100 collates the face information, regarding the person 3 who is detected in a prescribed range from a given boarding-dropping point, with the authentication data that is associated with the given boarding-dropping point. The operation support system 100 may authenticate the person 3 who has boarded the bus 1 at the boarding-dropping point, and may detect the authenticated person 3 as a potential passenger. Authentication of the person 3 based on the authentication data may be implemented by the operation support device 10, or may be implemented by the in-vehicle camera 20 or the image analysis unit 40 mounted on the bus 1.

Since the operation support device 10 detects potential passengers based on the boarding history at each boarding-dropping point, the detecting accuracy of the potential passengers can be enhanced.

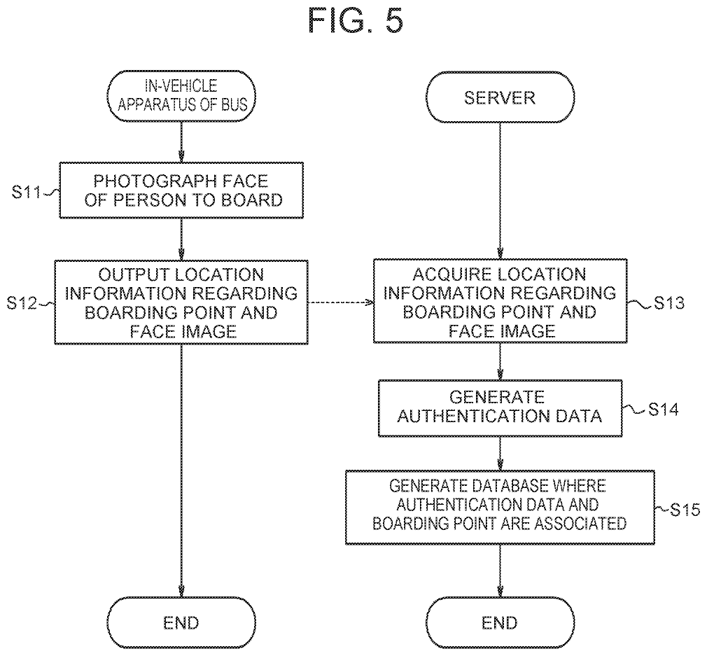

The operation support system 100 may execute a method including the procedure of a flowchart illustrated in FIG. 5, in order to generate the database where the location information regarding the boarding-dropping points is associated with the authentication data. The illustrated method may be implemented as a program executed by a processor. The in-vehicle camera 20, the location information acquisition device 25, the communication device 30, and the image analysis unit 40 mounted on the bus 1 are collectively referred to as an in-vehicle apparatus. In the illustrated procedure, it is assumed that the server 50 functions as the operation support device 10.

The in-vehicle apparatus of the bus 1 photographs the face of a person 3 to board (step S11). The photographed image of the face of the person 3 who boards the bus 1 is also called a face image.

The in-vehicle apparatus of the bus 1 outputs the location information regarding a boarding point of the person 3 and the face image of the person 3 to the server 50 (step S12). After executing the procedure of step S12, the in-vehicle apparatus of the bus 1 ends the execution of the procedure shown in the flowchart of FIG. 5.

The server 50 acquires the location information regarding the boarding point of the person 3 and the face image of the person 3 from the in-vehicle apparatus of the bus 1 (step S13).

The server 50 generates authentication data based on the face image (step S14). The server 50 may extract, from the face image, face information in conformity with a format of the authentication data.

The server 50 generates a database where authentication data and the boarding point of the person 3 who is authenticated based on the authentication data are associated with each other (step S15). After executing the procedure of step S15, the server 50 ends the execution of the procedure shown in the flowchart of FIG. 5.

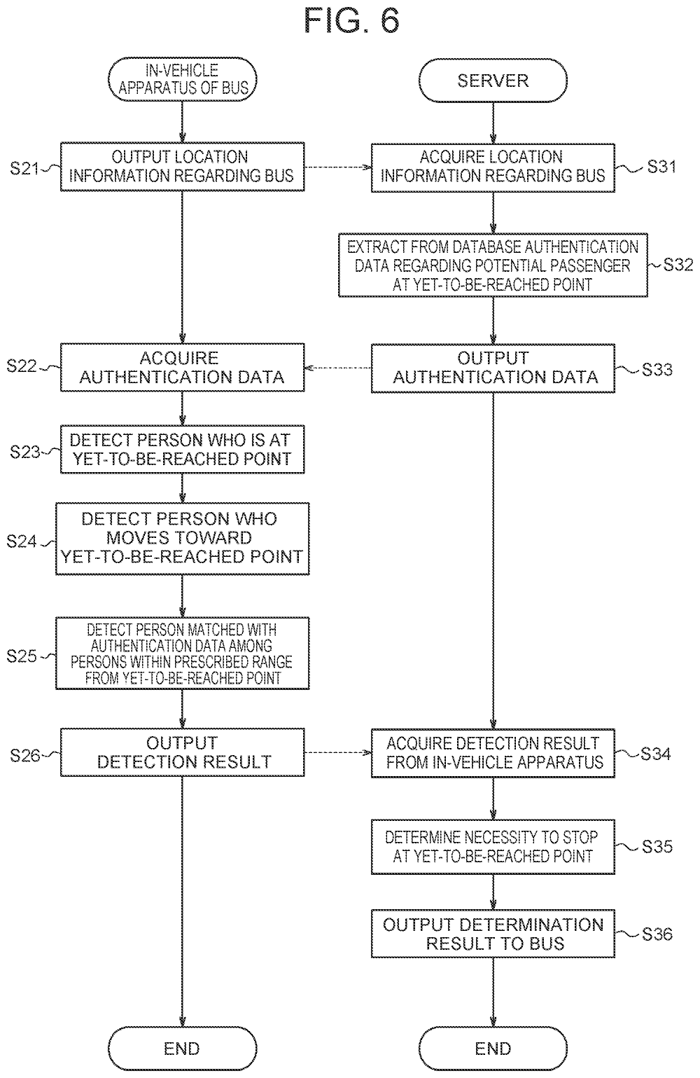

The operation support system 100 may implement the method including the procedure of a flowchart illustrated in FIG. 6, in order to detect a potential passenger based on the authentication data. The illustrated method may be implemented as a program executed by a processor. In the illustrated procedure, it is assumed that the server 50 functions as the operation support device 10.

The in-vehicle apparatus of the bus 1 outputs the location information regarding the bus 1 (step S21).

The server 50 acquires the location information regarding the bus 1 (step S31).

The server 50 extracts from the database authentication data regarding a potential passenger at a yet-to-be-reached point or points of the bus 1 (step S32). The yet-to-be-reached point is a boarding-dropping point at which the bus 1 traveling along an operation route has not yet arrived. The server 50 detects the yet-to-be-reached point or point of the bus 1 based on the location information regarding the bus 1. The server 50 extracts the authentication data associated with the yet-to-be-reached point in the database. When two or more yet-to-be-reached points are detected, the server 50 may extract the authentication data associated with all the yet-to-be-reached points, or may extract the authentication data associated with some of the yet-to-be-reached points. The server 50 may extract the authentication data that is associated with a next yet-to-be-reached point at which the bus 1 is scheduled to arrive. In the procedure of the flowchart illustrated in FIG. 6, the server 50 extracts the authentication data associated with the next yet-to-be-reached point at which the bus 1 is scheduled to arrive.

The server 50 outputs the extracted authentication data (step S33).

The in-vehicle apparatus of the bus 1 acquires from the server 50 the authentication data associated with the next yet-to-be-reached point at which the bus 1 is scheduled to arrive (step S22).

The in-vehicle apparatus of the bus 1 detects from an in-vehicle camera image a person 3 who is at the yet-to-be-reached point (step S23). The in-vehicle apparatus of the bus 1 may photograph, with the in-vehicle camera 20 included in the in-vehicle apparatus, the yet-to-be-reached point or the periphery thereof, and may detect person information regarding the person 3 who is at the yet-to-be-reached point, based on the in-vehicle camera image. The in-vehicle apparatus of the bus 1 may acquire, with the communication device 30, the in-vehicle camera image of a photographing vehicle 2 located at the yet-to-be-reached point or in the periphery thereof. The in-vehicle apparatus of the bus 1 may detect, with the image analysis unit 40, person information regarding the person 3 who is at the yet-to-be-reached point, based on the in-vehicle camera image of the photographing vehicle 2. The in-vehicle apparatus of the bus 1 may determine, based on the information regarding the action of the person 3, among the detected person information, whether the person 3 stays at the yet-to-be-reached point.

The in-vehicle apparatus of the bus 1 detects from the in-vehicle camera image a person 3 who moves toward the yet-to-be-reached point (step S24). The in-vehicle apparatus of the bus 1 may determine the person 3 who moves toward the yet-to-be-reached point along the operation route of the bus 1, or may detect the person 3 who moves toward the yet-to-be-reached point from the point out of the operation route of the bus 1. The in-vehicle apparatus of the bus 1 may photograph, with the in-vehicle camera 20 included in the in-vehicle apparatus, a point away from the yet-to-be-reached point, and may detect person information regarding the person 3, based on the in-vehicle camera image. The in-vehicle apparatus of the bus 1 may acquire, with the communication device 30, an in-vehicle camera image photographed by the photographing vehicle 2 at a point away from the yet-to-be-reached point. The in-vehicle apparatus of the bus 1 may detect, with the image analysis unit 40, the person information regarding the person 3, based on the in-vehicle camera image of the photographing vehicle 2. The in-vehicle apparatus of the bus 1 may determine, based on the information regarding the action of the person 3, among the detected person information, whether the person 3 moves toward the yet-to-be-reached point.

The in-vehicle apparatus of the bus 1 detects, from the in-vehicle camera image, a person 3 within a prescribed range from the yet-to-be-reached point, and detects the person 3 matched with the authentication data (step S25). The in-vehicle apparatus of the bus 1 may photograph, with the in-vehicle camera 20 included in the in-vehicle apparatus, the point within a prescribed range from the yet-to-be-reached point, and detect person information regarding the person 3 based on the in-vehicle camera image. The in-vehicle apparatus of the bus 1 may acquire, with the communication device 30, an in-vehicle camera image photographed by the photographing vehicle 2 at the point within the prescribed range from the yet-to-be-reached point. The in-vehicle apparatus of the bus 1 may detect, with the image analysis unit 40, person information regarding the person 3 based on the in-vehicle camera image of the photographing vehicle 2. The in-vehicle apparatus of the bus 1 is assumed to detect face information as the person information regarding the person 3 who is within the prescribed range of the yet-to-be-reached point. When detecting the face information regarding the person 3, the in-vehicle apparatus of the bus 1 collates the face information regarding the person 3 with authentication data, and determines whether the person 3 can be authenticated based on the authentication data. When the person 3 can be authenticated based on the authentication data, the in-vehicle apparatus of the bus 1 detects that the person 3 is a person matched with the authentication data.

The in-vehicle apparatus of the bus 1 outputs the detection result in each step from steps S23 to S25 to the server 50 (step S26). The in-vehicle apparatus of the bus 1 may execute all the procedures of steps S23 to S25, and output the result detected in each of the procedures. The in-vehicle apparatus of the bus 1 may execute the procedure of at least one step out of steps S23 to S25, and output the result detected in the procedure. The in-vehicle apparatus of the bus 1 may execute any procedure that can detect the presence of any potential passenger of the bus 1, instead of the procedure of each step from steps S23 to S25. After executing the procedure of step S26, the in-vehicle apparatus of the bus 1 ends the execution of the procedure shown in the flowchart of FIG. 6.

The server 50 acquires the detection result from the in-vehicle apparatus of the bus 1 (step S34).

The server 50 determines whether the bus 1 needs to stop at the yet-to-be-reached point (step S35). When there is a person 3 staying at the yet-to-be-reached point, the server 50 determines that the bus 1 needs to stop at the yet-to-be-reached point. When there is a person 3 who moves to the yet-to-be-reached point, the server 50 determines that the bus 1 needs to stop at the yet-to-be-reached point. When there is a person 3 matched with the authentication data in a prescribed range from the yet-to-be-reached point, the server 50 determines that the bus 1 needs to stop at the yet-to-be-reached point.

The server 50 outputs to the bus 1 the result of determining whether the bus 1 needs to stop at the yet-to-be-reached point (step S36). The server 50 may output the determination result to the travel controller 35 of the bus 1. The server 50 may generate operation support information based on the determination result, and output the information to the travel controller 35 of the bus 1. The travel controller 35 of the bus 1 controls the bus 1 to travel based on the determination result or the operation support information acquired from the server 50. After executing the procedure of step S36, the server 50 ends the execution of the procedure shown in the flowchart of FIG. 6.

In the method illustrated in FIG. 6, the server 50 may collectively determine the necessity to stop the bus 1 in all the yet-to-be-reached points. In that case, the server 50 may collectively output the authentication data regarding all the yet-to-be-reached points to the in-vehicle apparatus of the bus 1. The in-vehicle apparatus of the bus 1 may execute the procedure of step S25 for all the yet-to-be-reached points, and detect a person or persons 3 who can be authenticated with the authentication data.

In the method illustrated in FIG. 6, the in-vehicle apparatus of the bus 1 executes collation between the face information regarding the person 3 and the authentication data. In short, the in-vehicle apparatus of the bus 1 may implement one of the functions of the operation support device 10.

The operation support system 100 according to the one embodiment can detect a potential passenger based on the boarding history at a boarding-dropping point by executing the methods illustrated in FIGS. 5 and 6. Such configuration can enhance the detecting accuracy of the potential passenger. The accuracy of determining the necessity to stop the operation vehicle at a boarding-dropping point may also be enhanced. The necessity to stop the operation vehicle at a boarding-dropping point may be determined by executing other methods, instead of the methods illustrated in FIGS. 5 and 6.

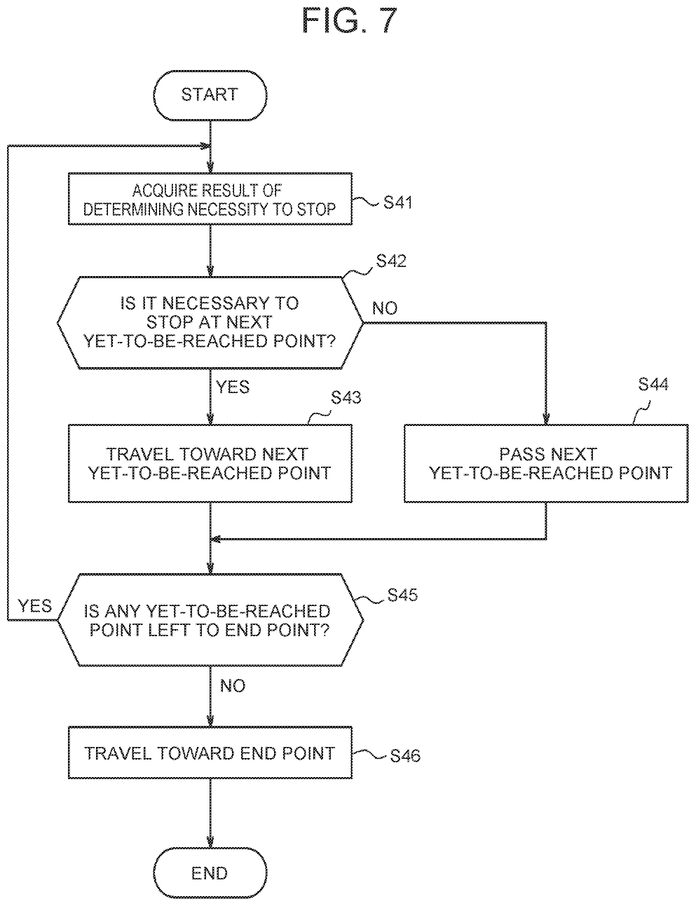

The bus 1 may travel based on the result of determining the necessity to stop at a yet-to-be-reached point obtained by executing a method such as the methods illustrated in FIGS. 5 and 6. The travel controller 35 controls the travel of the bus 1. The travel controller 35 may control the travel of the bus 1 by executing the method including the procedure of a flowchart illustrated in FIG. 7. The illustrated method may be implemented as a program executed by a processor.

The travel controller 35 acquires the result of determining the necessity to stop at a yet-to-be-reached point from the server 50 (step S41).

The travel controller 35 determines whether the bus 1 needs to stop at a next yet-to-be-reached point based on the acquired determination result (step S42).

When the bus 1 needs to stop at the next yet-to-be-reached point (step S42: YES), the travel controller 35 controls the bus 1 to travel toward the next yet-to-be-reached point (step S43). When the bus 1 does not need to stop at the next yet-to-be-reached (step S42: NO), the travel controller 35 controls the bus 1 to skip the next yet-to-be-reached point (step S44). After executing one of the step S43 and step S44, the travel controller 35 proceeds to step S45.

The travel controller 35 determines whether any yet-to-be-reached point remains from the yet-to-be-reached point where the bus 1 has stopped or skipped in one of step S43 and step S44 to an end point of the operation route of the bus 1 (step S45). When any yet-to-be-reached point remains to the end point (step S45: YES), the travel controller 35 returns to the procedure of step S41, and further acquires the result of determining the necessity to stop the bus 1 in the next yet-to-be-reached point.

When no yet-to-be-reached point remains to the end point (step S45: NO), the travel controller 35 travels toward the end point (step S46). After executing the procedure of step S46, the travel controller 35 ends the execution of the procedure shown in the flowchart of FIG. 7.

When the operation support system 100 collectively determines the necessity to stop the bus 1 at two or more yet-to-be-reached points in step S25 of FIG. 6, the travel controller 35 can collectively acquire the results of determining the necessity to stop the bus 1 at the yet-to-be-reached points in step S41 of FIG. 7. If the travel controller 35 should already acquire the result of determining the necessity to stop the bus 1 at all the yet-to-be-reached points to the end point, the travel controller 35 may skip the procedure of step S41. When the travel controller 35 already acquire the result of determining the necessity to stop the bus 1 in the next yet-to-be-reached point, the travel controller 35 may also skip the procedure of step S41.

The operation support system 100 according to the one embodiment can achieve efficient travel of the operation vehicle by determining the necessity to stop the operation vehicle based on the detection result of the potential passenger as illustrated in FIG. 7. For example, the operation support system 100 can shorten the time required for operation of the operation vehicle or improve the fuel efficiency of the operation vehicle by prohibiting the operation vehicle from stopping at the yet-to-be-reached point where no potential passenger is present. Traffic congestion attributed to the operation vehicle stopping at a boarding-dropping point can also be avoided. As a result, the convenience of the operation vehicle is enhanced.

### Change of Operation Route

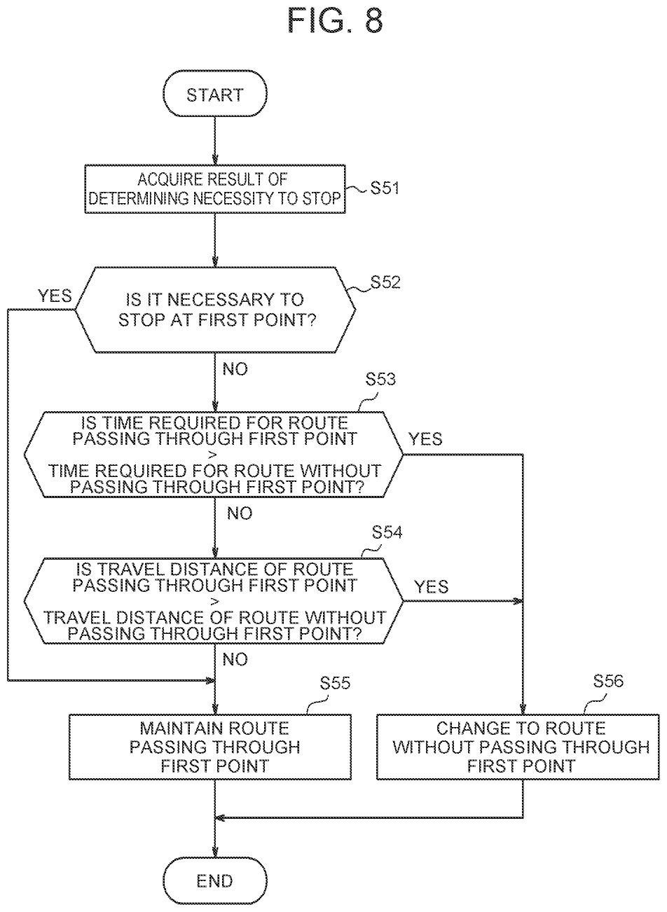

The operation support system 100 according to the one embodiment may change the operation route of the bus 1 based on the result of determining the necessity to stop the bus 1 at a boarding-dropping point. The operation support system 100 outputs to the bus 1 the changed operation route as operation support information. The server 50 that functions as the operation support system 100 may change the operation route of the bus 1 by executing the method including the procedure of a flowchart illustrated in FIG. 8.

The server 50 acquires the result of determining whether the bus 1 needs to stop at a prescribed yet-to-be-reached point (step S51). The result of determining the necessity to stop the bus 1 may be acquired by executing the methods illustrated in FIGS. 5 and 6, or may be acquired by executing other methods.

The server 50 determines whether the bus 1 needs to stop at a first point included in yet-to-be-reached points, among the boarding-dropping points included in the operation route of the bus 1 (step S52). When the bus 1 needs to stop at the first point (step S52: YES), the server 50 proceeds to the procedure of step S55.

When the bus 1 does not need to stop at the first point (step S52: NO), the server 50 determines whether the time required for an operation route passing through the first point is longer than the time required for an operation route without passing through the first route (step S53). The server 50 determines at least one alternate route as an operation route without passing through the first point. The server 50 may determine two or more alternate routes. The server 50 calculates the time required when the bus 1 operates along the operation route passing through the first point. The server 50 calculates the time required when the bus 1 operates along an alternate route. When determining two or more alternate routes, the server 50 calculates the time required when the bus 1 operates along each of the alternate route. The server 50 may calculate the required time based on a travel distance when the bus 1 operates along each of the routes. The server 50 may also calculate the required time based on information indicating congestion situations, such as traffic congestion information regarding each of the routes. When the time required for the operation route passing through the first point is longer than the time required for at least one of the alternate routes, the server 50 determines that the time required for the operation route passing through the first point is longer than the time required for the alternate routes.

When the time required for the operation route passing through the first point is longer than the time required for the operation route without passing through the first point (step S53: YES), the server 50 proceeds to the procedure of step S56. When the time required for the operation route passing through the first point is not longer than the time required for the operation route without passing through the first point (step S53: NO), the server 50 proceeds to the procedure of step S54. In short, when the time required for the operation route passing through the first point is equal to or shorter than the time required for the operation route without passing through the first point, the server 50 proceeds to the procedure of step S54.

When determining NO in step S53, the server 50 determines whether a travel distance in the operation route passing through the first point is longer than a travel distance in the operation route without passing through the first point, (step S54). The server 50 calculates the travel distance of the bus 1 when the bus 1 operates along the operation route passing through the first point. The server 50 calculates the travel distance of the bus 1 when the bus 1 operates along an alternate route determined in step S53. The server 50 may newly determine an alternate route, and calculate the travel distance of the bus 1 when the bus 1 operates along the alternate route. When determining two or more alternate routes, the server 50 calculates the travel distance of the bus 1 when the bus 1 operates along each of the alternate routes. When the travel distance in the operation route passing through the first point is longer than the travel distance in at least one of the alternate routes, the server 50 determines that the travel distance in the operation route passing through the first point is longer than the travel distance in the alternate routes.

When the travel distance in the operation route passing through the first point is longer than the travel distance in the operation route without passing through the first point (step S54: YES), the server 50 proceeds to the procedure of step S56. When the travel distance in the operation route passing through the first point is not longer than the travel distance in the operation route without passing through the first point (step S53: NO), the server 50 proceeds to the procedure of step S54. In short, when the travel distance in the operation route passing through the first point is equal to or shorter than the travel distance in the operation route without passing through the first point, the server 50 proceeds to the procedure of step S54.

When determining YES in step S52, or when determining NO in step S54, the server 50 maintains the route passing through the first point as the operation route of the bus 1 (step S55). For example, when a potential passenger is in the bus stop 4 in the example of FIG. 1, the operation support device 10 may maintain the operation route passing through the bus stop 4 expressed as R1, and allow the bus 1 to travel toward the bus stop 4. After executing the procedure of step S55, the server 50 ends the execution of the procedure shown in the flowchart of FIG. 8.

When determining YES in one of step S53 and step S54, the server 50 changes the operation route of the bus 1 to a route without passing through the first point (step S56). For example, in the example of FIG. 1, when no potential passenger is present in the bus stop 4, the operation support device 10 may change the operation route expressed as R1 to the operation route without passing through the bus stop 4 expressed as R2. When determining two or more alternate routes in step S53 or step S54, the server 50 may set the alternate route that allows operation in a shortest time as the operation route of the bus 1. The server 50 may set the alternate route that allows operation with a shortest travel distance as the operation route of the bus 1. After executing the procedure of step S56, the server 50 ends the execution of the procedure shown in the flowchart of FIG. 8.

In step S53, when the time required for the route passing through the first point and the time required for the alternate route are equal, the server 50 may proceed to step S56. In step S54, when the travel distance in the route passing through the first point, and the travel distance in the alternate route are equal, the server 50 may proceed to step S56.

The operation support system 100 according to the one embodiment can shorten the time required for operation of the operation vehicle by operating the operation vehicle in an alternate route, as illustrated to FIG. 8. Reducing the required time may reduce the waiting time of a user at the boarding-dropping point. The operation support system 100 can also improve the fuel efficiency of the operation vehicle by operating the operation vehicle in an alternate route. Efficient travel of the operation vehicle can be achieved by reducing the time required for operation of the operation vehicle, or improving the fuel efficiency of the operation vehicle. As a result, the convenience of the operation vehicle is enhanced.

Configuration Example of Operation Support Device in Case of being Mounted on Operation Vehicle

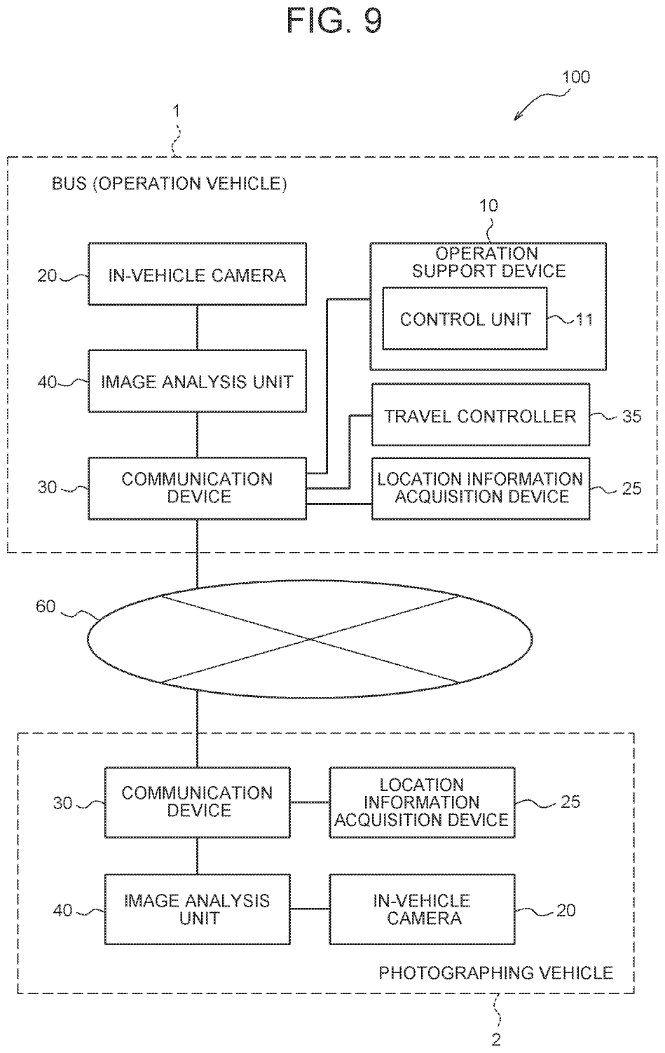

As shown in FIG. 9, the operation support device 10 may be mounted on the bus 1. When the operation support device 10 is mounted on the bus 1, the operation support device 10 may be implemented as one of the functions of the ECU of the bus 1. The bus 1 with the operation support device 10 mounted thereon has also the in-vehicle camera 20, the location information acquisition device 25, the communication device 30, the travel controller 35, and the image analysis unit 40 mounted thereon, in addition to the operation support device 10. The operation support device 10 may include a control unit 11. The control unit 11 may be implemented by one or more processors. The in-vehicle camera 20 or the image analysis unit 40 of the bus 1 may output camera output information to the operation support device 10 in the bus 1. Even when the operation support device 10 is mounted on the bus 1, the operation support device 10 can execute the same operation as in the case where the operation support device 10 is implemented as one of the functions of the server 50. The operation support device 10 mounted on the bus 1 may output operation support information to the travel controller 35 of its own vehicle.

### Support for Boarding Assistance

When the operation support system 100 detects as a potential passenger a person 3 who needs assistance for boarding the bus 1, such as a person sitting on a wheelchair, and a person using a cane, the operation support system 100 may output the detection result as the operation support information for the bus 1. The person 3 who needs assistance for boarding the bus 1 is also called a passenger in need of assistance. When the bus 1 is under automated driving control by the travel controller 35, the bus 1 may automatically set up a boarding aid, such as a slope, in the boarding-dropping point where the passenger in need of assistance waits. After confirming that the passenger in need of assistance boards the bus 1, the bus 1 may automatically pick up the boarding aid. Even after the passenger in need of assistance boards the bus 1, the travel controller 35 may prohibit the bus 1 from starting until the passenger in need of assistance moves to a safe position inside the bus 1. In short, the travel controller 35 may start the bus 1 after confirming that the passenger in need of assistance has moved to the safe location inside the bus 1.

While the embodiment of the present disclosure have been described with reference to drawings and examples, it is to be understood that those skilled in the art can easily make various transformations and corrections based on the present disclosure. Therefore, it is to be noted that these transformations and corrections are intended to be embraced in the range of the present disclosure. For example, the functions, or the like, included in each means, step, or the like, can be rearranged without causing logical inconsistency, and a plurality of means, steps, or the like, can be integrated into unity or can be divided.

What is claimed is:

1. An operation support device, comprising a control unit configured to output operation support information regarding an operation vehicle that operates along an operation route passing through prescribed boarding-dropping points to board or drop a passenger at the prescribed boarding-dropping point, wherein
the control unit is configured to
detect person information from an in-vehicle camera image by a photographing vehicle that is different from the operation vehicle,
detect a potential passenger at each of the prescribed boarding-dropping points based on the person information, and
output the operation support information based on a detection result of the potential passenger.

2. The operation support device according to claim 1, wherein the control unit outputs the operation support information based on a result of determining whether the potential passenger is present at a yet-to-be-reached point where the operation vehicle has not yet arrived, among the prescribed boarding-dropping points.

3. The operation support device according to claim 2, wherein
the yet-to-be-reached point includes a first point; and
when determining that no potential passenger is present in the first point, the control unit changes the operation route to a route without passing through the first point.

4. The operation support device according to claim 3, wherein
when time required for the operation vehicle to operate along the route without passing through the first point is shorter than time required for the operation vehicle to operate along a route passing through the first point, the control unit changes the operation route to the route without passing through the first point.

5. The operation support device according to claim 3, wherein when a travel distance in a case of the operation vehicle operating along the route without passing through the first point is shorter than a travel distance in a case of the operation vehicle operating along a route passing through the first point, the control unit changes the operation route to the route without passing through the first point.

6. The operation support device according to claim 1, wherein
the control unit acquires, as the person information, at least one of location information, behavior information, state information, and biometric information regarding a person detected from the in-vehicle camera image.

7. An operation support system, comprising:
an operation vehicle configured to operate along an operation route passing through prescribed boarding-dropping points to board or drop a passenger at prescribed boarding-dropping points;
a photographing vehicle different from the operation vehicle; and
an operation support device including a control unit configured to output operation support information regarding the operation vehicle, wherein
the control unit of the operation support device is configured to
detect person information from an in-vehicle camera image by the photographing vehicle,
detect a potential passenger at each of the prescribed boarding-dropping points based on the person information, and
output the operation support information based on a detection result of the potential passenger.

8. An operation support program for causing a processor to execute the steps of:
detecting person information from at least one of in-vehicle camera images by a photographing vehicle that is different from an operation vehicle that operates along an operation route passing through prescribed boarding-dropping points to board or drop a passenger at the prescribed boarding-dropping points;
detecting a potential passenger at each of the prescribed boarding-dropping points based on the person information; and
outputting operation support information regarding the operation vehicle based on a detection result of the potential passenger.
